(19) United States
(12) Patent Application Publication
(10) Pub. No.: US 2014/0263899 A1
(43) Pub. Date: Sep. 18, 2014

(54) APPARATUS FOR MOUNTING A PHOTOVOLTAIC MODULE

(71) Applicant: UNIRAC, INC., Albuquerque, NM (US)

(72) Inventors: Stacy HARRIS, Albuquerque, NM (US); Todd GANSHAW, Albuquerque, NM (US); Kyle BARR, Albuquerque, NM (US); Ernest GALLEGOS, Albuquerque, NM (US); Juan SUAREZ, Albuquerque, NM (US)

(73) Assignee: Unirac, Inc., Albuquerque, NM (US)

(21) Appl. No.: 13/840,866

(22) Filed: Mar. 15, 2013

(51) Int. Cl. F24J 2/52; F16M 13/02

(52) U.S. Cl. CPC F24J 2/5245; F16M 13/022
USPC 248/220.21

(57) ABSTRACT

An apparatus for mounting a photovoltaic module is disclosed. The apparatus includes a mounting member and an engagement member attached to the mounting member. The engagement member is longitudinally fixed on the mounting member and the engagement member is moveable with respect to the mounting member.

### BACKGROUND OF THE INVENTION

The solar industry is growing world-wide and, as a result, more-efficient structures are desirable for mounting a photovoltaic module to a structure, such as a roof of a home or other building. Whereas many different structures are known, there is a desire to reduce the complexity of such structures, and reduce the number of components in such structures.

Further, it is desirable to provide an apparatus that is not restricted to any particular photovoltaic module design, but rather, can be configured to mount PV modules of many different manufacturers, i.e., the apparatus is not a proprietary design of any particular PV module manufacturer.

Therefore, there is a need for an improved apparatus for mounting a photovoltaic module.

### BRIEF DESCRIPTION OF THE DRAWINGS

FIG. 1 is a perspective view of several apparatuses for mounting a photovoltaic module in accordance with an embodiment of the invention as disposed on a roof;

FIG. 2 illustrates the apparatuses of FIG. 1 as used to mount several photovoltaic modules to the roof;

FIGS. 3A and 3B illustrate an embodiment of the apparatus of the present invention with components of the apparatus in different positions;

FIG. 3C is a side view of the apparatus in the position of FIG. 3B;

FIG. 4 is a perspective view of an embodiment of the apparatus of the present invention with a micro-inverter attached to the mounting member;

FIG. 5 is a bottom perspective view of the apparatus of FIG. 4;

FIG. 6 illustrates a tool that can be utilized in conjunction with the apparatus in adjusting a height of the mounting member with respect to a footer of the apparatus;

FIG. 7 is a partial cut-away perspective view that illustrates the tool of FIG. 6 where the tool is engaged with an engagement member to rotate the engagement member;

FIG. 8 is a partial cut-away perspective view that illustrates the engagement member rotated to engage frames of adjacent photovoltaic modules;

FIGS. 9A and 9B illustrate an alternative embodiment for an engagement member in accordance with the principles of the present invention;

FIGS. 10A and 10B illustrate another alternative embodiment for an engagement member in accordance with the principles of the present invention; and

FIGS. 11A and 11B illustrate a further alternative embodiment for an engagement member in accordance with the principles of the present invention.

### DETAILED DESCRIPTION OF THE DRAWINGS

FIG. 1 is a perspective view of several apparatuses 100 disposed on a roof 200 for mounting photovoltaic (PV) modules on the roof in accordance with an embodiment of the present invention. The apparatuses 100 are disposed on the roof 200 parallel to each other and can be secured to the roof by, for example, bolting the apparatuses to flashing of the roof.

FIG. 2 illustrates PV modules 300 mounted on the apparatuses 100 of FIG. 1. A side of a PV module that has a longest length, i.e., the longitudinal length, is disposed parallel to the apparatus 100. Where an apparatus 100 is disposed between two adjacent PV modules, a single apparatus 100 is used to mount the adjacent sides of both of the adjacent PV modules to the roof. Where an apparatus 100 is disposed next to a non-adjacent side of a PV module, that apparatus 100 mounts only the non-adjacent side of the PV module to the roof.

Again, as can be seen in FIG. 2, a single apparatus 100 is utilized on a non-adjacent side of a PV module 300 and a single apparatus 100 is utilized between two adjacent PV modules. Thus, the number of apparatuses 100 required for mounting PV modules 300 equals n+1, where n is the number of PV modules 300.

FIGS. 3A and 3B illustrate an embodiment of the apparatus 100 in further detail. As will be further described, FIG. 3A illustrates a base member 130 of the apparatus 100 in a first position with respect to a mounting member 110 and FIG. 3B illustrates the base member 130 in a second position with respect to the mounting member 110.

The apparatus 100 for mounting a photovoltaic module includes the mounting member 110 and an engagement member 120. In the illustrated embodiment, the mounting member 110 is an elongated member that has a length L that is much greater than its width W and depth D. In this embodiment, the mounting member 110 is a flat bar that is basically homogeneously formed. Thus, it does not include any tracks or hollow chambers that extend substantially along the length of the mounting member 110, as are included in known rails for mounting PV modules.

In this illustrated embodiment, an engagement member 120 is disposed at each longitudinal end of the mounting member 110. However, the present invention is not limited to an elongated mounting member and an engagement member at each longitudinal end of the mounting member. For example, a single engagement member could be disposed on a much shorter mounting member. This shorter mounting member, with a single engagement member, could mount one end of the side of a PV module and a similarly configured mounting member could mount the other end of that side of the PV module. Therefore, the present invention is not limited to the particular illustrated embodiment of an elongated mounting member with two engagement members.

In the illustrated embodiment, the engagement members 120 each include a first engagement structure 122 and second engagement structure 123. The engagement structures 122, 123 are disposed at opposite ends of a base member 124 of the engagement member. As can be further seen with reference to FIG. 3C, each of the engagement structures 122, 123 include a plate that defines a slot between the plate and the base member 124. FIG. 3C illustrates plate 122A of engagement structure 122 that defines slot 125 between plate 122A and base member 124. The other engagement member 120 disposed on the other end of mounting member 110 in FIG. 3C is similarly configured, as discussed above. The engagement structures, and associated plates, may be integrally formed with the base member as a single component piece or these structures may be different structures that are connected together. The present invention is not limited to any particular way of forming the engagement structures.

As will be further explained, a respective frame of adjacent PV modules is received within the respective slots of the first and second engagement structures 122, 123. Thus, the engagement members 120, through engagement structures 122, 123, engage the frames of adjacent PV modules to mount the PV modules on the apparatus 100 when the engagement members 120 are rotated to engage the PV module frames in the slots 125 of the engagement members 120. The frame of a first PV module is engaged by engagement structure 122 and a frame of a second, adjacent PV module is engaged by engagement structure 123.

The engagement members 120 are positionably longitudinally fixed on the mounting member 110. Thus, the engagement members 120 are not variably positionable along the length of the mounting member 110. The engagement members are longitudinally fixed to the mounting member when the apparatus is brought to the installation site. Thus, the mounting member 110 and the engagement members 120 are configured as a single assembled structure when installed on a roof. This is in contrast to a rail-based system where a clamp is a separate component from a rail and is longitudinally fixed to the rail after the clamp is positioned along a track of the rail when mounting the PV module to the rail. Further, since the apparatus is not a rail-based system, no in-the-field cutting of a rail is required to provide the required length of rail from an expansive length of rail.

However, whereas the engagement members 120 are positionably longitudinally fixed on the mounting member 110, they are movable with respect to the mounting member 110. For example, as with the illustrated embodiment of FIGS. 3A-C, the engagement members 120 are able to rotate in their fixed position with respect to mounting member 110. Other embodiments for engagement members, to be discussed later in this specification, disclose other movements with respect to the mounting member.

The engagement members 120 may be secured to mounting member 110 by utilizing any of a variety of known connecting devices, e.g., rivets, bolts, etc. All that is required is that the engagement member be positionably longitudinally fixed on the mounting member, but yet, moveable with respect to the mounting member.

As mentioned previously, apparatus 100 also includes a base member 130. The base member 130 is rotationally attached to the mounting member 110. FIG. 3B illustrates this rotational movement of base member 130 with respect to mounting member 110. In FIG. 3A, the base member 130 is disposed parallel to the length of the mounting member 110. This position may be most-convenient for providing a compact apparatus for shipping purposes, for example. In FIG. 3B the base member 130 is disposed perpendicularly to mounting member 110. In the position as illustrated in FIG. 3B for the base member 130 with respect to the mounting member 110, the mounting member 110 is linearly moveable on base member 130. This can provide for adjustment of the position of the mounting member 110 for accommodating specific widths of PV modules that are mounted on the apparatus 100.

As can be further seen, the base member 130 is disposed on a side of the mounting member 110 that faces the roof and the engagement members 120 are disposed on an opposing side of the mounting member 110 that faces the PV modules.

As can be seen in FIG. 3C, the base member 130 is attached to roof 200 through a securing device 132, such as a lag bolt, etc. Other connecting hardware connects the mounting member 110 to the base member 130. This connecting hardware may be a bolt 133 and a plate 134 that is received within a track 135 of base member 130. Thus, the mounting member 110 is connected to the roof 200 via the base member 130.

The mounting member 110 is connected to base member 130 such that, as described previously, the mounting member 110 is linearly slidable in the track 135 of base member 130. As can be understood, through connecting hardware 133, 134 and track 135, the mounting member 110 may be securely fixed to base member 130, and additionally, the base member 130 may be rotated with respect to the mounting member 110 and the mounting member 110 may be linearly moved on the base member 130. Further, the height position of the mounting member 110 with respect to the base member 130, and thus the roof 200, may also be adjustable though the connecting hardware, if required. Of course, many different types of connecting hardware may be contemplated for performing these functions and the present invention is not limited to the illustrated embodiment.

The base member 130 may also include a footer 136 on each end of the base member 130 to provide for supporting the base member 130, and consequently the mounting member 110, on the roof.

Apparatus 100 may further include spacer members 140. A spacer member 140 is positioned at each longitudinal end of mounting member 110.

The spacer members 140 extend substantially perpendicular to the mounting member and the spacer members 140 are disposed on the mounting member 110 at a location on the mounting member that is substantially at a mid-point of the width of the mounting member. In use, when apparatus 100 is used to mount adjacent PV modules to the same apparatus 100, spacer members 140 can be utilized to accurately position the frames of the adjacent PV modules with respect to the apparatus 100. For example, the frames of the adjacent PV modules can be brought into contact with the spacer member 140 from each side of the apparatus 100 such that in this position of the frames, the edges of the frames are positioned generally over a mid-point of the width of the apparatus such that the frames can be engaged by the engagement members 120.

Apparatus 100 may further include a connecting member 150. Connecting member 150 is disposed between the engagement members 120 at each end of the mounting member 110. The connecting member 150 is connected at each of its ends 152, 154 to a respective engagement member 120. The connecting member 150 serves to connect the two engagement members 120 together such that a rotation of one engagement member 120 will result in a rotation of the other engagement member 120 due to the connection of the two engagement members 120 together via the connecting member 150. The connecting member 150 can be connected to the respective base member 124 of each connecting member 120.

Apparatus 100 may also include first and second footers 160 at the opposing longitudinal ends of the mounting member 110. Each footer 160 provides a support for the mounting member 110 on the surface of the roof, and as will be further explained in connection with FIG. 3C, the height of the mounting member 110 above the roof 200 is adjustable through use of the footers 160 and a threaded member 165 of each footer 160.

As can be seen in FIG. 3C, the threaded members 165 are received within respective threaded boreholes defined by the mounting member 110. By threading the threaded members 165 up and down in the threaded boreholes, the height of the mounting member 110 above the footers 160, and thus above the roof, can be adjusted to finely tune the position of the mounting member 110 with respect to the PV modules. The threaded members 165, and thus the threaded boreholes in mounting member 110, are disposed on the mounting member 110 at a location on the mounting member that is substantially at a mid-point of the width of the mounting member.

The footers 160 can be rigidly fixed to the threaded members 165 or the threaded members 165 can rest on top of the footers 160. In either case, through rotation of the threaded members, the height of the mounting member 110 can be adjusted. The adjusting of the height of the mounting member 110 can also be accommodated for by the connecting hardware between the mounting member 110 and the base member 130, e.g., the adjustable threading of the bolt 133 in the plate 134.

FIG. 4 is a perspective view of an embodiment of the apparatus 100 of the present invention with an electrical micro-inverter 170 attached to the mounting member 110. The micro-inverter 170 can be rigidly attached to mounting member 110 through appropriate mounting hardware. As is known, the micro-inverter converts direct current (DC) to alternating current (AC). Micro-inverter 170 includes DC cabling 172 that couples to a PV module, either directly or indirectly, to conduct direct current from the PV module to the micro-inverter 170. The direct current is then converted in micro-inverter 170 to alternating current and conducted through cable 174 to, for example, a trunk cable connection 176 for further distribution of the alternating current, e.g., to a house electrical circuit.

The apparatus 100 can include built-in “plug-and-play” module connections for the DC cables 172 and for connection of cable(s) from the PV module(s) to the mounting member 110. As such, the mounting member interconnects the PV module electrical cable to the micro-inverter's DC cables 172. FIG. 4 illustrates the DC cables 172 connected to such built-in plug-and-play module connections in the mounting member 110. Cable clips can also be provided on the mounting member 110 for securing the cabling 172, 174 to apparatus 100.

As discussed previously, and as will be discussed further, the engagement members 120 are rotated to engage the PV module frames in the slots 125 of the engagement members 120. This rotation, which draws the PV module frames into engagement with the apparatus 100, can also serve to engage the PV module electrical cables with the module connections of the mounting member 110.

The structural connection between the micro-inverter 170 and mounting member 110 can also provide for a ground connection between the micro-inverter 170 and the mounting member 110. For example, connection hardware of the micro-inverter 170 pierces, for example, an aluminum anodized surface of the mounting member 110 to create a bond/ground connection between the micro-inverter 170 and the mounting member 110.

Whereas the present invention may provide modules for connecting the DC cables 172 to the PV module cables, the present invention is not limited to any particular embodiment for connecting the DC cables 172 to the PV module cables. For example, the DC cables 172 can be directly connected to the PV module cables instead of use of built-in module connections in the mounting member 110, as described above.

FIG. 5 is a bottom perspective view of the apparatus 100 of FIG. 4. In this bottom view, the base member 130 and the footers 160 can be seen on the side of the mounting member 110 that is disposed facing the roof.

FIG. 6 illustrates a tool 400 that can be utilized in conjunction with the apparatus 100 for adjusting a height of the mounting member 110 with respect to a footer 160 of the apparatus 100. The tool 400 engages with the threaded member 165, described previously. By threading the threaded member 165 either up or down within the threaded borehole of the mounting member 110, the threaded member 165 can be used to adjust the height of the mounting member 110 with respect to the footer 160, particularly at this location of the mounting member 110 which engages with the frame of the PV module(s) through engagement members 120. Thus, the height, and consequently the position of the mounting member 110, and engagement member 120, can be finely tuned for optimal engagement with the frame of the PV module(s) to account, for example, for any irregularities in the surface of the roof.

Also illustrated in FIG. 6 is structure 126 of the engagement member 120 that also is engageable with tool 400. When tool 400 engages in the structure 126 of engagement member 120, this same tool 400 can be utilized to rotate engagement member 120 into/out of its engagement position with the frame of a PV module. Thus, the same tool can be utilized for both rotating the engagement member 120 and adjusting the height of the mounting member 110 with respect to the footer 160. This engagement structure 126 of engagement member 120 may be any structure that is capable of receiving tool 400 and rotating engagement member 120 along with rotation of tool 400. For example, engagement structure 126 can be an aperture defined by base member 124 of engagement member 120 or can be additional structure attached to base member 124 that is capable of receiving the tool 400. This engagement structure is disposed on the mounting member 110 at a location on the mounting member that is substantially at a mid-point of the width of the mounting member.

Also shown in FIG. 6, the apparatus 100 may also include shims 112 on the mounting member 110. Shims 112 can also be utilized to adjust the positioning of the PV module frame on the mounting member 110.

FIG. 7 is a partial cut-away perspective view that illustrates the tool 400 of FIG. 6 where the tool 400 is engaged with the engagement structure 126 of engagement member 120 to rotate the engagement member 120. FIG. 8 is a similar partial cut-away view.

As can be seen in FIG. 7, adjacent PV modules 300 are disposed on a single apparatus 100. The adjacent frames 310, 312 are disposed between the engagement structures 122, 123 of engagement member 120. Tool 400 is inserted between the adjacent PV modules, and between the adjacent frames 310, 312 of the PV modules, and into the engagement structure 126 of engagement member 120, which is substantially located in the center of engagement member 120. In FIG. 7, the engagement member 120, in this position, does not yet engage frames 310, 312 in slots 125 of engagement structures 122, 123.

As discussed, and as can be seen with reference to both FIGS. 7 and 8, the tool 400 is used to rotate engagement member 120 such that first engagement structure 122 of engagement member 120 engages frame 310 of PV module 300 in slot 125 of engagement structure 122. Likewise, engagement structure 123 of engagement member 120 engages frame 312 of the adjacent PV module 300 in slot 125 of engagement structure 123. Thus, in this rotated position for engagement member 120, the frames 310, 312 of the adjacent PV modules 300 are received within the slots 125 defined by the engagement structures 122, 123 of engagement member 120, respectively. Therefore, as can be understood, through rotation of engagement member 120, the frames 310, 312 of adjacent PV modules 300 are mounted on apparatus 100 through engagement of the frames with the engagement member 120 of the apparatus 100. As can be further seen in both FIGS. 7 and 8, spacer member 140 is disposed between the frames 310, 312 of the adjacent PV modules 300 to assist, as described previously, in the positioning of the frames on the apparatus 100.

Since the tool 400 is able to access both the threaded members 165 and engagement members 120 between the frames of the adjacent PV modules when the PV modules are positioned on the apparatus 100, the adjustment of the height of the mounting member 110 through threaded members 165 and footers 160 and the rotation of the engagement members 120 can be done after the PV modules are positioned on the apparatus. This is made possible by the location of the threaded members 165 and engagement structures 126 of engagement members 120, and spacer members 140, on the mounting member 110 at a location on the mounting member that is substantially at a mid-point of the width of the mounting member. In this position, these structures are located between the adjacent frames of the PV modules when the PV modules are positioned on the apparatus 100, and are thus accessible between the adjacent frames.

FIGS. 9A and 9B illustrate an alternative embodiment for an engagement member 1120 in accordance with the principles of the present invention. Engagement member 1120 includes a first engagement structure 1122 and a second engagement structure 1123. Both the first engagement structure 1122 and the second engagement structure 1123 extend substantially vertically with respect to the mounting member 110. The engagement member 1120 can be directly connected to mounting member 110, or alternatively, can be connected to mounting member 110 through other intermediate structure.

As can be further seen in FIGS. 9A and 9B, first engagement structure 1122 includes a first slanted cam surface 1122A. Similarly, second engagement structure 1123 includes second slanted cam surface 1123A. Engagement member 1120 may also include base support 1124.

With this embodiment for engagement member 1120, as can particularly be seen in FIG. 9B, frames 310, 312 of adjacent PV modules are pressed downward on cam surfaces 1122A and 1123A, respectively. This downward pressure of the frames on the cam surfaces move the engagement structures 1122, 1123 outwardly such that the frames 310, 312 can slide down the cam surfaces and be positioned between an underside of the cam surfaces and the base support 1124. Thus, the frames 310, 312 are engaged by the engagement member 1120 and, thus, mounted on the mounting member 110.

FIGS. 10A and 10B illustrate another alternative embodiment for an engagement member 2120 in accordance with the principles of the present invention. Engagement member 2120 includes a first engagement structure 2122 and a second engagement structure 2123. Engagement structure 2122 defines a slot 2122A and engagement structure 2123 defines a slot 2123A. The engagement structures 2122 and 2123 are linearly moveable, across the width of the mounting member 110, on mounting member 110 and slot 110A. Again, as with the previous embodiment, mounting structures 2122, 2123 may be directly mounted on mounting member 110 or mounted on mounting member 110 through intermediate structure. As can be understood, frame 310 of a PV module is received within slot 2122A of first engagement structure 2122. Frame 312 of an adjacent PV module is received within slot 2123A of second engagement structure 2123. As such, the frames 310, 312 are engaged by the engagement member 2120 and, thus, mounted on the mounting member 110.

As discussed above, the engagement structures 2122, 2123 of engagement member 2120 are linearly moveable on the mounting member 110. In the illustrated embodiment, a spring 2124 is disposed between the first engagement structure 2122 and the second engagement structure 2123. When a release 2125 is triggered, in an embodiment, this release unlocks engagement structures 2122, 2123 from an extended position apart from each other, where frames 310, 312 are inserted into the respective slots of the engagement structures, and then the spring 2124 draws the engagement structures 2122, 2123 together such that the respective frames are secured within the respective slots. The engagement structures may be manually drawn into their extended positions. However, the present invention is not limited to any particular embodiment for linearly moving the engagement structures with respect to each other to both receive and secure the frames of adjacent PV modules within the slots of the engagement structures.

FIGS. 11A and 11B illustrate a further alternative embodiment for an engagement member 3120 in accordance with the principles of the present invention. As can be seen, engagement member 3120 includes first engagement structure 3122 and second engagement structure 3123. Engagement structure 3122 includes a slot 3122A and engagement structure 3123 includes a slot 3123A. Engagement structures 3122, 3123 are rotationally moveable with respect to mounting member 110. Again, engagement members 3122, 3123 can be directly rotationally mounted on mounting member 110 or can be rotationally mounted on mounting member 110 through intermediate structure. Both first engagement structure 3122 and second engagement structure 3123 include rounded cam surfaces 3122B, 3123B, respectively, such that downward pressure on the cam surfaces by frames 310, 312 of adjacent PV modules rotates the engagement structures around a pivot point 3122C, 3123C, respectively, such that the frames of the PV modules are received within the respective slots of the respective engagement structures. Thus, downward pressure by frame 310 on the cam surface 3122B of first engagement structure 3122 rotates the first engagement structure such that frame 310 is received within slot 3122A of first engagement structure 3122. Similarly, downward pressure by frame 312 on cam surface 3123B of second engagement structure 3123 rotates second engagement structure 3123 such that frame 312 is received within slot 3123A of second engagement structure 3123. The first and second engagement structures 3122, 3123 can be locked in their rotated positions in engagement with the respective frames of the PV modules.

The apparatus of the present invention is not limited to any particular materials for the apparatus. For example, the apparatus could be made of stamped or rolled steel, extruded aluminum, injection molded plastic, or pultruded fiberglass. Further, whereas the present invention was disclosed as including an apparatus 100 that is mounted to a roof and then a PV module is mounted on the apparatus 100, the present invention is not limited to this mounting sequence for the apparatus 100 and a PV module 300. For example, the apparatus 100 could be pre-assembled to a single PV module or between hinged assemblies of two PV modules, i.e., assembled before transport to the installation site, and then transported to the installation site and installed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for mounting a photovoltaic module, comprising:
a mounting member; and
an engagement member attached to the mounting member, wherein the engagement member is longitudinally fixed on the mounting member and wherein the engagement member is moveable with respect to the mounting member.

2. The apparatus according to claim 1, further comprising a second engagement member, wherein the engagement member is disposed at a first end of the mounting member, wherein the second engagement member is disposed at a second end of the mounting member, wherein the second engagement member is longitudinally fixed on the mounting member, and wherein the second engagement member is moveable with respect to the mounting member.

3. The apparatus according to claim 1, wherein the engagement member includes a first engagement structure at a first end of the engagement member and a second engagement structure at a second end of the engagement member.

4. The apparatus according to claim 3, wherein the first engagement structure includes a first plate, wherein a first slot is defined between a base member of the engagement member and the first plate, and wherein the second engagement structure includes a second plate, wherein a second slot is defined between the base member of the engagement member and the second plate.

5. The apparatus according to claim 1, wherein the engagement member includes a first engagement structure and a second engagement structure, wherein the first engagement structure extends substantially vertically with respect to the mounting member and includes a first cam surface, and wherein the second engagement structure extends substantially vertically with respect to the mounting member and includes a second cam surface.

6. The apparatus according to claim 1, wherein the engagement member includes a first engagement structure and a second engagement structure, wherein the first engagement structure is linearly moveable with respect to the mounting member and defines a first slot, and wherein the second engagement structure is linearly moveable with respect to the mounting member and defines a second slot.

7. The apparatus according to claim 6, further comprising a spring disposed between the first engagement structure and the second engagement structure.

8. The apparatus according to claim 1, wherein the engagement member includes a first engagement structure and a second engagement structure, wherein the first engagement structure is rotationally moveable with respect to the mounting member and defines a first slot, and wherein the second engagement structure is rotationally moveable with respect to the mounting member and defines a second slot.

9. The apparatus according to claim 2, further comprising a connecting member disposed between the engagement member and the second engagement member and attached to the engagement member and the second engagement member.

10. The apparatus according to claim 1, further comprising a first footer and a second footer, wherein the first footer is attached to a first end of the mounting member and wherein the second footer is attached to a second end of the mounting member.

11. The apparatus according to claim 10, wherein the mounting member is vertically adjustable with respect to the first footer and the second footer.

12. The apparatus according to claim 10, wherein the first footer is attached to the first end of the mounting member by a first threaded member, wherein the second footer is attached to the second end of the mounting member by a second threaded member, and wherein the first and second threaded members are disposed within respective first and second threaded boreholes defined by the mounting member.

13. The apparatus according to claim 1, further comprising a spacer member disposed on the mounting member, wherein the spacer member extends substantially perpendicular to the mounting member.

14. The apparatus according to claim 13, wherein the spacer member is disposed on the mounting member at a location on the mounting member that is substantially at a mid-point of a width of the mounting member.

15. The apparatus according to claim 1, further comprising a base member, wherein the base member is rotationally attached to the mounting member, wherein the base member is disposed on a first side of the mounting member, and wherein the engagement member is disposed on a second side of the mounting member.

16. The apparatus according to claim 15, wherein the mounting member is linearly moveable on the base member.

17. The apparatus according to claim 1, further comprising a micro-inverter attached to the mounting member.

18. The apparatus according to claim 1, wherein the mounting member is an elongated flat bar and wherein the flat bar does not include a track that extends substantially along a longitudinal length of the bar.

19. The apparatus according to claim 12 in combination with a tool, wherein the tool is engageable with the engagement member and with the first and second threaded members.

20. The apparatus according to claim 1 in combination with a photovoltaic module, wherein the mounting member is disposed substantially parallel to a side of the photovoltaic module that has a longest length and wherein the engagement member engages a frame of the photovoltaic module.
